(19) United States
(12) Patent Application Publication
(10) Pub. No.: US 2011/0027475 A1
(43) Pub. Date: Feb. 3, 2011

(54) METHOD AND DEVICE FOR STRUCTURING A SURFACE

(75) Inventors: Markku Rajala, Vantaa (FI); Sampo Ahonen, Espoo (FI)

Correspondence Address: OLIFF & BERRIDGE, PLC, P.O. BOX 320850, ALEXANDRIA, VA, 22320-4850, US

(73) Assignee: BENEQ OY, VANTAA (FI)

(21) Appl. No.: 12/742,586

(22) PCT Filed: Dec. 9, 2008
(86) PCT No.: PCT/FI08/50719

§ 371 Date: May 12, 2010

(30) Foreign Application Priority Data
Dec. 10, 2007 (FI) 20070953

(51) Int. Cl. B05D 1/06; B05C 19/04

(52) U.S. Cl. 427/180; 118/308

(57) ABSTRACT

The invention relates to a method and a device for structuring a surface of a material by directing at a surface to be structured (9) a particle spray structuring the surface. The invention comprises separating from the particle spray, by means of at least one impaction nozzle (7), particles larger than a determined size d2, which particles are directed at the surface to be structured (9) such that they collide with the surface, producing a structure thereon.

### BACKGROUND OF THE INVENTION

The present invention relates to a method of structuring a surface, and particularly to a method of structuring a surface according to the preamble of claim 1, the method comprising directing at a surface a particle spray structuring the surface. The present invention further relates to a device for structuring a surface, and particularly to a device for structuring a surface of a material by a microstructure and/or a nanostructure according to the preamble of claim 14, the device comprising at least means for directing a particle spray at a surface to be structured.

The structure of a surface plays an important role as far as the properties of several products are concerned. A known example is a Lotus surface wherein a hydrophobic surface is transformed into a superhydrophobic one because the surface is provided with bumps that are spaced at distances of 20 to 40 micrometres from one another and, further, because the entire surface contains wax crystals of 200 to 2000 nanometres in size. More generally, it can be stated that by changing the micro/nanostructure of a surface, an initially hydrophilic or hydrophobic surface may be transformed into a superhydrophilic or superhydrophobic surface. A superhydrophilic and/or superhydrophobic surface is economically significant when manufacturing self-cleaning surfaces or surfaces that stay easily clean.

U.S. Pat. No. 3,354,022, published on 21 Nov. 1967, E.I. du. Pont de Nemours and Company, discloses a water-repellent surface whose water-repellency is based on the surface being provided with bumps that are spaced at an average distance of at most 1000 micrometers from one another and that have a height of at least half the average distance.

U.S. Pat. No. 6,811,856B2, published on 2 Nov. 2004, Creavis Gesellschaft für Technologie and Innovation GmbH, discloses a self-cleaning surface with a hydrophobic surface structure formed by means of differences in height on the surface which are produced by particles affixed the surface. The particles are 20 to 500 nm in size.

In addition to self-cleanability, hydrophobic surfaces are significant in fluidics, particularly when trying to decrease flow resistance of channels. U.S. Pat. No. 6,852,390 B2, published on 8 Feb. 2005, Entegris, Inc., discloses an ultraphobic surface produced by means of uniformly shaped differences of micro or nanoscale from the surface. In Physics of Fluids, vol. 16, no. 12, December 2004, Jia Ou, Blair Perot & Jonathan P. Rothstein, “Laminar drag reduction in microchannels using ultrahydrophobic surfaces”, pp. 4635 to 46-43, it is shown that the flow resistance of a laminar flow channel may be substantially reduced if the surface of the flow channel has a uniform microscale structure.

Self-cleaning surfaces are of great economical importance e.g. in windows. U.S. Pat. No. 6,997,018 B2, published on 14 Feb. 2006, Ferro Corporation, discloses a method of micro- and nanostructuring a glass surface. The method is based on affixing inorganic particles having a diameter of less than 400 nm to the surface of the glass when the temperature of a glass article is within a range of 700 to 1200° C.

A micro/nanostructured surface also plays an important role in medicine, e.g. in biomedical systems wherein the materials used are not to show hemocompatibility. One significant point having influence on this is that the surfaces being used have to be resistant to adhesion of proteins in blood to the surface. One method of improving this resistance is surface nanostructuring.

A surface structure is also important for bone affixation to an implant; however, research results on the significance of surface chemistry and surface structure are partly controversial.

The effect of a micro/nanostructure on the refractive index of a surface is also very significant economically since the structure may be used e.g. for producing a gradually changing refractive index, which enables an anti-reflective surface to be achieved. An antireflective and hydrophobic combination surface is disclosed in Nanotechnology 18, 2007, Y. C. Chang et al., “Design and fabrication of a nanostructured surface combining antireflective and enhanced-hydrophobic effects”, pp. 1 to 6.

However, a surface nanostructure may also have detrimental effects. Materials Research, vol. 10, no. 1, C. Diaz et al., “Influence of the Nano-micro Structure of the Surface on Bacterial Adhesion” discloses that bacterial adhesion to a micro-structured surface is lesser than to a smooth surface but bacterial adhesion to a nano-structured surface is greater than to a smooth surface.

A surface may be structured either uniformly or non uniformly, i.e. randomly. In practice, randomly structured surfaces are more relevant since they are less expensive to manufacture. Micro- and nanostructures have been manufactured onto surfaces by several methods, such as lithography, etching, micro-stamping, chemical vapor disposition (CVD), and physical vapor disposition (PVD).

U.S. Pat. No. 6,309,798 B1, published on 30 Oct. 2001, Studiengesellschaft Kohle mbH, discloses a lithographic method for nano-structuring a surface. The lithographic method requires multiphase surface processing, thus not being an advantageous method for structuring large surfaces.

U.S. Pat. No. 6,468,916 B2, published on 22 Oct. 2002, Samsung SDI Co., Ltd., discloses a method of forming a nano-sized surface structure. The method comprises several steps: forming a microstructure, depositing a carbon polymer layer on top of the micro-structured surface, a first plasma etching process, creating a mask layer, and a second reactive etching. This method thus also requires multiphase surface processing, so it is not an advantageous method for structuring large surfaces.

The method described in U.S. Pat. No. 6,997,018 for structuring a surface of glass is a useful structuring method for large surfaces, but it is limited to structuring a glassy surface at a temperature of more than 700° C.

The prior art methods are incapable of structuring a surface in an advantageous and controlled manner. Furthermore, the known methods and devices are incapable of structuring with a micro- and/or nanostructure having an adjustable size range such that the method would also be usable and advantageous for structuring large surfaces. It is thus clear that a need exists for such a method and device.

### BRIEF DESCRIPTION OF THE INVENTION

An object of the invention is thus to provide a method and an apparatus implementing the method so as to enable the aforementioned problems to be solved.

The object of the invention is achieved by a method according to the characterizing part of claim 1, characterized by comprising separating from the particle spray, by at least one impaction nozzle, particles larger than a determined size d₂, and directing these particles at the surface to be structured such that they collide with the surface to be structured, producing a structure thereon. The object of the invention is further achieved by a device according to the characterizing part of claim 14, characterized in that the device comprises at least one impaction nozzle for separating particles larger than a determined size d₂ from the particle spray.

Preferred embodiments of the invention are disclosed in the dependent claims.

According to the invention, particles larger than a diameter d₁ may first be separated from a group of particles G₀ by an impactor. Next, the group of particles is led through a subsequent impactor nozzle, and particles larger than a diameter d₂ are allowed to collide with the surface to be modified, whereupon they provide the surface with a structure whose size depends on the diameters d₁ and d₂. The structure produced on the surface by means of the particles d₂ is at least a nanostructure, but it may also comprise both a nano-structure and a microstructure. Further, particles larger than a diameter d₃ may be separated from the same group of particles by means of the impactor, whereafter also particles larger than a diameter d₄ (<d₃) are separated and led through a subsequent impaction nozzle and allowed to collide with the surface to be modified, the particles providing the surface with a structure whose size depends on the diameters d₃ and d₄ and whose scale is smaller than that of the structure dependent on the diameters d₁ and d₂. Preferably, the structure may be produced on the surface of a moving web, which enables differently scaled structures to be produced onto the same surface during the same process. It is obvious to one skilled in the art that the structuring according to the method may also be produced in more than two phases and that the diameters d₂ and d₃ may also be equal in size. In accordance with the above, the method of the invention enables first a microstructure and subsequently a nanostructure to be produced onto a surface to be structured. This is achieved by selecting appropriately the size of the particles colliding with the surface to be structured at a given time. In such a case, a first impaction nozzle is used for separating from the particle spray particles larger than a determined size d₂, and these particles are directed at the surface to be structured such that they collide with the surface to be structured and wear a substantially microstructure thereon, and a second impaction nozzle is used for separating from the particle spray particles larger than a determined size d₄, d₄<d₂, and these particles are directed at the surface to be structured such that they collide with the surface to be structured and wear a substantially nanostructure thereon. In other words, in the device and method according to the present invention, impaction nozzles may be arranged in series such that in the first impaction nozzle, a rougher particle distribution is produced from the particle spray, wherefrom e.g. particles smaller than the size d₂ are led to a subsequent impaction nozzle used for producing a finer particle distribution, etc.

According to the method, the surface may be provided with a microstructure typically having a scale of 1 to 1000 micrometres and/or a nanostructure typically having a scale of 1 to 1000 nanometres. In the method, the particles that collide with the surface to be structured either wear a structure on the surface, in which case once the particles have collided with the surface to be structured they bounce off this surface, or, alternatively, at least some of the particles that collide with the surface to be structured become affixed thereto, depositing a structure on the surface to be structured. It is further to be noted that in some cases, wear and deposition of the surface to be structured may also take place at least partly simultaneously. The fact of whether surface structuring takes place by means of wear or deposition depends primarily on the surface material and secondarily on the properties of the particles used, such as the quantity of movement and the size of the particles.

Preferably, the device according to the invention is integrated in a manufacturing or processing process of a product, such as a float glass manufacturing device, flat glass tempering device, sheet metal production or processing device, plastic film roller-to-roller processing device, plastic product extrusion process, ceramic tile production process or the like. It is obvious to one skilled in the art that these are only examples of a preferred manner of integrating the device and that they do not limit the use of the device according to the invention in other applications.

### BRIEF DESCRIPTION OF THE FIGURES

The invention is now described in closer detail in connection with preferred embodiments and with reference to the accompanying drawings, in which

FIG. 1 shows an embodiment of the invention and illustrates a method of structuring a surface according to the invention; and

FIG. 2 shows another embodiment of the invention, wherein smallest particles are removed from an aerosol before structuring a surface.

### DETAILED DESCRIPTION OF THE INVENTION

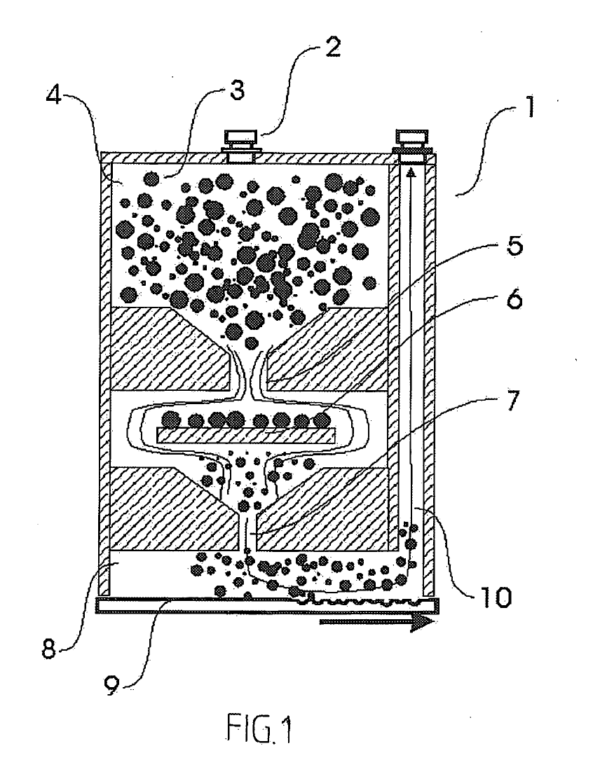

FIG. 1 shows a schematic cross-section of a single-stage structuring device 1 according to an embodiment of the invention, the figure at the same time illustrating the method according to the invention. Preferably, the device 1 comprises means 2 for feeding an aerosol containing particles 3 into the device 1, means for controlling the pressure of the aerosol in a chamber 4 (not shown), an impaction nozzle 5, a collector substrate 6, means for conveying aerosol to another impaction nozzle 7, means 8 for conveying aerosol to a surface 9 to be structured, means 10 for conveying aerosol away from the surface 9 to be structured, and means for controlling the pressure of an aerosol discharge channel (not shown). In a simplest case, the flow rate of aerosol may serve as the pressure control but, when necessary, the pressure may be increased above the normal air pressure in the chamber 4, and/or the aerosol discharge channel 10 may have a pressure lower than the normal air pressure. The aerosol comprising particles 3 is fed to the chamber 4 of the device, the aerosol being led through a first impaction nozzle 5. The collector substrate 6 is arranged behind this first impaction nozzle 5 in the flow direction, on which substrate particles larger than size d₁ are caught/affixed while particles smaller than d1 are forwarded to the second impaction nozzle 7 enabling particles larger than a determined size d₂ to be separated from a particle spray, these particles being conveyed to a surface 9 to be structured such that they collide with the surface 9 to be structured. The operation of an impaction nozzle is generally based on the fact that the velocity of particles passing through a nozzle gap of the impaction nozzle accelerates according to the properties of the particles and the dimensions and properties of the nozzle gap, whereby the particles obtain a certain quantity of motion while passing through the nozzle gap. When the downstream side of the nozzle is provided with a substrate towards which the particle spray from the impaction nozzle is directed, particles with sufficient kinetic energy collide with the surface of the substrate while particles with no sufficient quantity of motion are led away from the surface of the substrate such that they do not collide with the surface. Consequently, particles larger than a determined size D obtain a quantity of motion sufficient for them to collide with the substrate, whereas particles smaller than said size D do not collide with the substrate.

It is obvious to one skilled in the art that if an aerosol being fed to the device 1 contains no particles larger than the size d₁, the impaction nozzle 5 and the collector substrate 6 may be omitted from the device 1.

The aerosol to be supplied to the device 1 contains particles 3 whose shape may be arbitrary. Preferably, the shape of the particles differs from spherical and the surface of the particles is provided with edges or the like.

The mathematical equations set forth in the present application are from William C. Hinds, Aerosol Technology, Properties, Behavior, and Measurement of Airborne Particles, 2^{nd} Edition, John Wiley & Sons, Inc., New York, 1999.

The width of the gap of the impaction nozzle 5 is an essential parameter for collecting particles larger than the size d₁ onto the collector substrate 6. The collecting effectiveness E_{f} of the collector substrate 6 depends on the Stokes number (Stk), which is determined for a rectangular gap of an impaction nozzle by:

$$Stk = \frac{τ U}{H / 2} = \frac{{ρ}_{p} {d}_{p}^{2} {UC}_{c}}{9 η H} \qquad ( 1 )$$

wherein τ is relaxation time, U is gas velocity, H is the width of the gap of the impaction nozzle 6, ρₚ is particle density, dₚ is particle diameter, C_{c} is the Cunningham correction factor, and η is viscosity. The gas velocity U is affected substantially by the pressure of the chamber 4 and the discharge channel 10.

If the particles are not spherical, the particle size of Equation 1 has to be corrected by a dynamic size factor χ, which typically ranges between 1 and 2.

Particles smaller than the particle size d₁ proceed to the impaction nozzle 7, wherein the velocity of the particles accelerates and particles larger than size d₂ collide with the surface 9 to be structured. The purpose of the method is that the particles colliding with the surface 9 to be structured bounce off the surface 9, leaving a mark on the surface 9, the mark structuring the surface, or, alternatively, become affixed to the surface 9, depositing a structure thereon. The phenomenon of a particle bouncing off a surface is more likely with larger particles and higher particle velocities and with particles consisting of hard materials. In order to wear the surface 9, it is preferable to use oxide particles, such as aluminium oxide, carbide particles, such as silicon carbide, or nitride particles, such as boron nitride, as the particles for the device 1. Further, the bouncing of particles off a surface is affected by the material and initial structure of the surface to be structured, and the use of the method is most preferable when the method is used for structuring smooth, hard and clean surfaces, e.g. a glass or metal surface. Consequently, the particles colliding with the surface to be structured produce at least a nanostructure onto the surface to be structured. In other words, in the present invention a nanostructure is produced by providing the surface to be structured with more material, or by removing material from the surface to be structured, or by modifying the surface to be structured by making particles collide therewith.

No bouncing of particles occurs if the particle velocity does not exceed a critical velocity V_{c}, which is defined by

$${V}_{c} = \frac{β}{{d}_{a}} \qquad ( 2 )$$

wherein b is a constant which depends on the materials used (particles and surface) and the geometry and which typically ranges from 1 to 100×10⁻⁶ m²/s, and dₐ is the aerodynamic diameter of a particle.

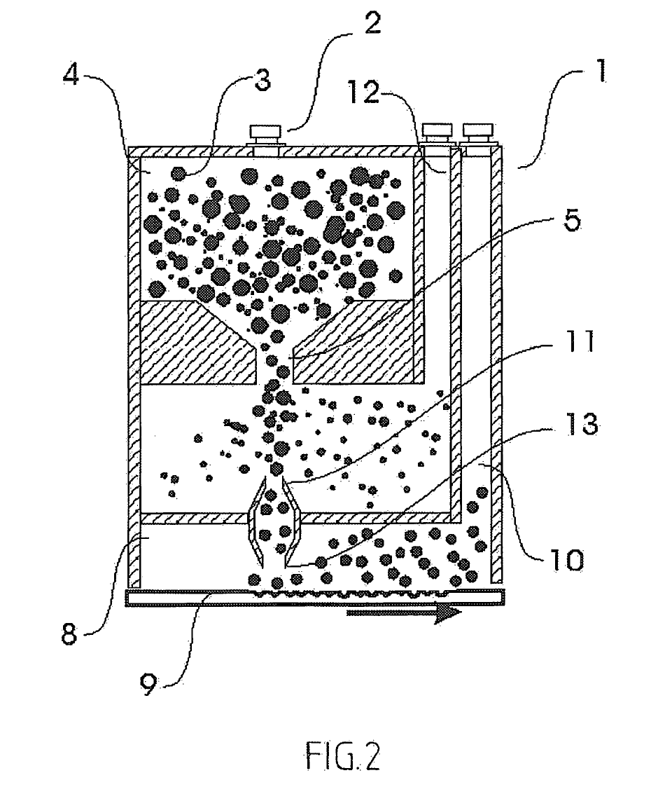

FIG. 2 shows a schematic cross-section of a single-stage structuring device 1 according to another embodiment of the invention. Preferably, the device 1 comprises means 2 for feeding an aerosol comprising particles 3 into the device 1, means for controlling the pressure of the aerosol in a chamber 4 (no pressure control means are depicted in the figure), a virtual impactor 11 which separates particles smaller and larger than the size d₂, means for conveying particles smaller than the particle size d₂ away from the device 12, means 8 for supplying aerosol to the surface 9 to be structured, means 10 for conveying aerosol away from the surface 9 to be structured, and means for controlling the pressure of the aerosol discharge channel (not shown). In a simplest case, the flow rate of the aerosol may serve as the pressure control but, when necessary, the pressure may be increased above the normal air pressure in the chamber 4, and/or the aerosol discharge channel 10 may have a pressure lower than the normal air pressure. The device according to this embodiment provides the advantage that particles smaller than the size d₂ can be removed from the gas flow before they collide with the surface 9 to be structured. Since a vast majority of the flow passes to the channel 12, an output 13 of the virtual impactor has been constricted in order to increase the particle velocity. The particle velocity may be increased in all embodiments also e.g. by supplying an additional gas flow after an impaction nozzle, by means of an electric field or otherwise.

A structure to be produced by the method according to the invention onto a room-temperature glass or aluminium surface was studied by way of example. Spherical pieces having a diameter of 25 mm were manufactured from aluminium foil by a punching device, and the pieces were loaded into an impactor (ELPI), manufactured by Dekati Oy, for different impactor degrees within a size range of 30 nanometres to 10 micrometres. Further, in place of a standard collector substrate, the same impactor was provided with a custom-made collector substrate and in this collector substrate a spherical piece made of soda-glass was installed. Nano-sized aluminium oxide particles (Al₂O₃) were produced by a liquid flame spraying apparatus according to Finnish Patent No. 98832. In a liquid flame spray, a raw material solution was used wherein 64 g of aluminium nitrate was dissolved in 76 g of methanol. The solution was fed to the liquid flame spray at a velocity of 17 ml/min. Similarly, in order to produce a flame, hydrogen was fed to the liquid flame spray at a volume flow of 50 ml/min and oxygen at a volume flow of 25 l/min. The raw material solution evaporates and vaporizes in the liquid flame spray, producing small aluminium particles. Some of the particles were collected into the aforementioned impactor when the collecting distance was 100 mm from the front surface of the nozzle of the liquid flame spray. In a first measurement, a peak of size distribution of the particles was determined, the peak settling at about 110 nm. The aluminium substrates used in the measurement were recovered for SEM measurement. Next, the custom-made substrate and a glass sample were placed at the impactor settling at the size distribution peak, and an identical sample was run through the impactor. After the runs the samples were washed with a dish-washing agent and water. The samples were then analyzed by a scanning electron microscope, the magnification being 60 000× and the acceleration voltage being 10 kV. In accordance with the tests, it was observed that with the parameters according to the example, the method according to the invention produces scratches of about 100 nm in length and some nanometres in thickness on the surface of the glass. No nano-sized particles become substantially affixed to the surface of the glass. According to the tests, it was observed in the aluminium surface processed by the method that the particles produced collided tightly with the relatively soft aluminium surface, producing a nanostructure thereon. In other words, the particles affixed to the aluminium surface, depositing a structure thereon.

The solutions disclosed in the aforementioned embodiments may be combined with one another, and it is possible to couple differently-dimensioned devices in series such that a first device produces a microstructure onto a surface and a second device produces a nanostructure on top of the microstructure. The method and device of the present invention are not restricted to the size of the particles used and/or the size of the particles directed at the surface to be structured since the wear in the surface to be structured caused by the particles colliding therewith or the structure being deposited on the surface depends on the material and properties of the surface to be structured as well as on the material and properties of the particles. Thus, the structure provided on each surface to be structured is a result of the combined effect of both the properties of the particles colliding with the surface and the properties of the surface itself to be structured.

The method and device according to the invention may be used for structuring a surface of glass by wearing when the surface of the glass is sufficiently hard. This condition is met when the temperature of the glass is below a lower cooling limit, e.g. in the case of soda-glass below 490° C. Hence, the device according to the invention may be integrated in the glass production line (float line) or at a point of the glass processing line where the temperature of the glass is below that lower cooling limit. It is to be noted that when the surface of the glass is soft, which condition is met when the temperature of the glass is higher than the cooling limit, the method according to the invention may be used for providing the surface of the glass with a structure which is not caused by a surface wearing effect, as in the case of hard glass, but by a nanomaterial depositing effect.

Preferably, the method according to the invention may also be used for structuring e.g. metal surfaces, e.g. when producing a nanostructured surface for a fingerprint rejecting metal surface or when producing an advantageous bone growing surface onto a surface of a metal implant.

It is obvious to those skilled in the art that as technology advances, the basic idea of the invention may be implemented in many different ways. The invention and its embodiments are thus not restricted to the above-described examples but may vary within the scope of the claims.

1. A method of structuring a surface of a material, the method comprising directing at a surface (9) to be structured a particle spray structuring the surface, characterized by separating from the particle spray, by at least one impaction nozzle (7, 11), particles larger than a determined size d₂, and directing these particles at the surface (9) to be structured such that they collide with the surface (9) to be structured, producing a structure thereon.

2. A method as claimed in claim 1, characterized by separating from the particle spray, by at least one impaction nozzle (7, 11), particles larger than the determined size d₂, and directing these particles at the surface (9) to be structured such that they collide with the surface (9) to be structured, producing a nanostructure having a scale of 1 to 1000 nanometres and/or a microstructure having a scale of 1 to 1000 micrometres.

3. A method as claimed in claim 1 or 2, characterized by directing particles larger than the determined size d₂ at the surface (9) to be structured such that they wear a structure thereon.

4. A method as claimed in any one of the preceding claims 1 to 3, characterized by directing particles larger than the determined size d₂ at the surface (9) to be structured such that at least some of the particles become affixed to the surface (9) to be structured, depositing a structure thereon.

5. A method as claimed in any one of the preceding claims 1 to 4, characterized by separating particles larger than a determined size d₁, d₁ being larger than d₂, from the particle spray prior to separating particles of the size d₂ from the particle spray.

6. A method as claimed in any one of the preceding claims 1 to 5, characterized by separating particles smaller than the determined size d₂ from the particle spray before particles larger than the size d₂ collide with the surface (9) to be structured.

7. A method as claimed in claim 6, characterized by separating particles smaller than the determined size d₂ by a virtual impactor (11).

8. A method as claimed in any one of the preceding claims 1 to 7, characterized by an average velocity of particles of the determined size d₂ being higher than a critical velocity characteristic of the particle in question and the surface (9) to be structured, particles moving at a velocity lower than the critical velocity becoming affixed the surface (9) to be structured.

9. A method as claimed in claim 8, characterized by increasing the velocity of the particles above the critical velocity by accelerating the velocity of the particles in the impaction nozzle (5, 7, 11) or thereafter.

10. A method as claimed in any one of the preceding claims 1 to 9, characterized by the particles (3) being used having a shape different from that of spherical particles.

11. A method as claimed in any one of the preceding claims 1 to 10, characterized by the particles (3) being used being oxide, carbide or nitride particles.

12. A method as claimed in any one of the preceding claims 1 to 11, characterized by producing by the method first a microstructure and subsequently a nanostructure onto the surface (9) to be structured.

13. A method as claimed in claim 12, characterized by separating from the particle spray, by a first impaction nozzle (5), particles larger than the determined size d₂, which particles are directed at the surface (9) to be structured such that they collide with the surface (9) to be structured and wear a substantial microstructure thereon, and separating from the particle spray, by a second impaction nozzle (7), particles larger than a determined size d₄, d₄<d₂, which particles are directed at the surface (9) to be structured such that they collide with the surface (9) to be structured and wear a substantially nanostructure thereon.

14. A device for structuring a surface of a material with a microstructure and/or a nanostructure, the device comprising at least means (8) for directing a particle spray at a surface (9) to be structured, characterized in that the device comprises at least one impaction nozzle (7) for separating particles larger than a determined size d₂ from the particle spray.

15. A device as claimed in claim 14, characterized in that the device comprises at least one other impaction nozzle (5) for separating particles larger than a determined size d₁ (d₁>d₂) from the particle spray.

16. A device as claimed in claim 14 or 15, characterized in that the device comprises at least one virtual impaction nozzle (11) for separating particles smaller than the determined size d₂ from the particle spray.

17. A device as claimed in any one of the preceding claims 14 to 16, characterized in that it comprises means for increasing a velocity of the particle spray in the impaction nozzle (5, 7, 11) or thereafter.

18. A device as claimed in any one of the preceding claims 14 to 17, characterized in that the device is integrated in a manufacturing or processing line of flat glass at a point where a temperature of the glass is below a lower cooling limit of the glass.

19. A device as claimed in any one of the preceding claims 14 to 18, characterized in that the device is integrated in a manufacturing or processing line of a metal product.
